(19) United States
(12) Patent Application Publication
(10) Pub. No.: US 2026/0369827 A1
(43) Pub. Date: Nov. 19, 2026

(54) SECONDARY BATTERY

(71) Applicant: Samsung SDI Co., Ltd., Yongin-si (KR)

(72) Inventors: Jae Hyeon YUN, Yongin-si (KR); Seo Kyo JEOUNG, Yongin-si (KR); Han Byeol JANG, Yongin-si (KR); Eun Seok OH, Yongin-si (KR)

(21) Appl. No.: 19/677,932

(22) Filed: May 14, 2026

(30) Foreign Application Priority Data
May 19, 2025 (KR) 10-2025-0064289

(51) Int. Cl. H01M 50/533; H01M 50/103; H01M 50/119; H01M 50/15

(52) U.S. Cl. CPC H01M 50/533; H01M 50/103; H01M 50/119; H01M 50/15; H01M 2220/30

(57) ABSTRACT

A secondary battery includes: an electrode assembly including a first electrode plate, a second electrode plate, and a separator laminated on each other, the electrode assembly having rounded corners; a first cover member on a stacked side of the electrode assembly; a second cover member at a corner of the electrode assembly and covering an uppermost side, lateral sides, and a lowermost side of the corner of the electrode assembly; and a case accommodating the electrode assembly, the first cover member, and the second cover member.

### CROSS-REFERENCE TO RELATED APPLICATION

The present application claims priority to and the benefit of Korean Patent Application No. 10-2025-0064289, filed on May 19, 2025, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Unlike a primary battery, a secondary battery may be charged and discharged. Low-capacity secondary batteries having a single battery cell packaged in the form of a pack are widely employed in small, portable electronic devices, such as smart phones, feature phones, laptop computers, digital cameras, camcorders, and the like, while large-capacity secondary batteries are widely used as power sources for driving motors in hybrid vehicles, electric vehicles, and the like, as well as batteries for power storage. The secondary battery includes an electrode assembly consisting of a positive electrode and a negative electrode, a case that accommodates the electrode assembly, and electrode terminals connected to the electrode assembly.

The above information disclosed in this Background section is only for enhancement of understanding of the background of the invention and therefore it may contain information that does not constitute prior art.

### SUMMARY

Embodiments of the present disclosure provide a secondary battery that avoids or prevents case welding defects by arranging a cover member at a corner of an electrode assembly.

However, the technical problems to be achieved in the embodiment of the disclosure are not limited to the technical problems mentioned above, and other technical problems not mentioned herein will be clearly understood from the following description by those skilled in the art to which the disclosure belongs.

A secondary battery, according to one embodiment of the present disclosure, includes: an electrode assembly comprising a first electrode plate, a second electrode plate, and a separator laminated on each other, the electrode assembly having rounded corners; a first cover member on a stacked side of the electrode assembly; a second cover member at a corner of the electrode assembly; and a case accommodating the electrode assembly, the first cover member, and the second cover member. The second cover member wraps around an uppermost side, lateral sides, and a lowermost side of the corner of the electrode assembly.

In some embodiments, the second cover member may be at a plurality of corners of the electrode assembly.

In some embodiments, the second cover member may have a shape corresponding to the corner shape of the electrode assembly.

In some embodiments, the second cover member may include: a bridge on a side of a corner of the electrode assembly; an upper surface connected to the bridge and on the uppermost side of the corner of the electrode assembly; and a lower surface connected to the bridge and on the lowermost side of the corner of the electrode assembly.

In some embodiments, a length of the bridge may correspond to a stacked height of the electrode assembly.

In some embodiments, the upper surface and the lower surface may have a rhombus, trapezoid, or fan shape.

In some embodiments, the second cover member may further include a wing part extending from the bridge to one side.

In some embodiments, the wing part may extend along the stacked side of the electrode assembly.

In some embodiments, the wing part may extend from the bridge of the second cover member at one corner of the electrode assembly to the bridge of the second cover member at the other corner of the electrode assembly .

In some embodiments, the wing part may further include an extending wing part that wraps around the uppermost side and the lowermost side of the electrode assembly.

In some embodiments, the wing part may extend from the bridge of the second cover member at one corner of the electrode assembly to the first cover member.

In some embodiments, the first cover member may include: a first surface on the uppermost side of the electrode assembly; a second surface extending from the first surface and on the stacked side of the electrode assembly; and a third surface extending from the second surface and on the lowermost side of the electrode assembly.

In some embodiments, the first cover member and the second cover member may be integrally formed.

In some embodiments, the first cover member and the second cover member may be separated from each other.

In some examples, an R value, which is a radius of an arc of the corner of the electrode assembly, may be in a range of 2.0 mm to 3.5 mm.

In some examples, an R value, which is a radius of an arc of the corner of at least one side of the case, may be in a range of 2.0 mm to 2.5 mm.

In some embodiments, a left corner and a right corner of the electrode assembly may have different radii.

In some embodiments, the case may include: a first case having a recess in a central area for accommodating the electrode assembly therein and having one open side; and a second case sealing the open side of the first case. The first case may include an extension part extending from one end of the recess and coupled to the second case.

In some embodiments, the case may be made of steel, stainless steel, nickel-plated steel, or a steel alloy.

According to embodiments of the present disclosure, by providing a cover member at a rounded corner of an electrode assembly, interference between the electrode assembly and the case is reduced or minimized, thereby preventing case welding defects and improving product completion.

However, the technical effects to be achieved in the embodiment of the disclosure are not limited to the technical problems mentioned above, and other technical effects not mentioned herein will be clearly understood from the following description by those skilled in the art to which the disclosure belongs.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing a secondary battery according to an embodiment of the present disclosure.

FIG. 2 is a cross-sectional view taken along the line A-A' of the secondary battery shown in FIG. 1.

FIG. 3 is a cross-sectional view taken along the line B-B' of the secondary battery shown in FIG. 1.

FIG. 4 is an exploded perspective view of a case of the secondary battery shown in FIG. 1.

FIG. 5 is a perspective view of an electrode assembly of the secondary battery according to the present disclosure.

FIG. 6 is a plan view of the electrode assembly shown in FIG. 5 accommodated in a case.

FIG. 7 is a plan view showing a state before a cover member is wrapped around the electrode assembly shown in FIG. 5.

FIG. 8 is a plan view of a second cover member according to an embodiment.

FIG. 9 is a plan view of a second cover member including a wing part extending to one side according to an embodiment.

FIG. 10 is a plan view of a second cover member including a wing part extending to the opposite side according to an embodiment.

FIG. 11 is a plan view of a second cover member including wing parts extending to both sides according to an embodiment.

FIG. 12 is a plan view of a fan-shaped second cover member according to an embodiment.

FIG. 13 is a plan view of a trapezoidal second cover member according to an embodiment.

FIG. 14 is a plan view of a second cover member integrally formed to wrap around both lower corners of an electrode assembly according to an embodiment.

FIG. 15 is a plan view of a second cover member integrally formed to wrap around both lower corners of an electrode assembly and including a wing part according to an embodiment.

FIG. 16 is a plan view of a first cover member and a second cover member integrally formed to wrap around an electrode assembly according to an embodiment.

FIG. 17 is a perspective view of a secondary battery according to an embodiment of the present disclosure.

FIG. 18 is a cross-sectional view taken along the line C-C’ of the secondary battery shown in FIG. 17.

FIG. 19 is an exploded perspective view of the secondary battery shown in FIG. 17.

FIG. 20 is a view schematically showing a smartphone equipped with a secondary battery pack according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. In addition, it will be understood that the terms "comprise or include" and/or “comprising or including,” when used in this specification, specify the presence of stated features, integers, steps, operations, elements, and/or components but do not preclude the presence or addition of one or more other features, integers, steps, operations, elements, components, and/or groups thereof. In addition, when describing embodiments of the present disclosure, the wording “may ~” or “may be~” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” etc., may be used herein to describe various components, these components should not be limited by these terms. These terms are used to distinguish one component from another component. Thus, unless otherwise defined, a first component described below could be termed a second component, without departing from the spirit and scope of the present disclosure.

Throughout the specification, the singular forms are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “coupled to,” “linked to,” or “ “connected to” another element, these elements can be directly coupled or connected to each other, another intervening element may be present therebetween, or the respective elements may be coupled, linked, or connected to each other through another elements. In addition, it will be understood that when an element is referred to as being electrically coupled to another element, the element can be directly connected to another element or an intervening element may be present therebetween such that the element and another element are indirectly connected to each other.

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

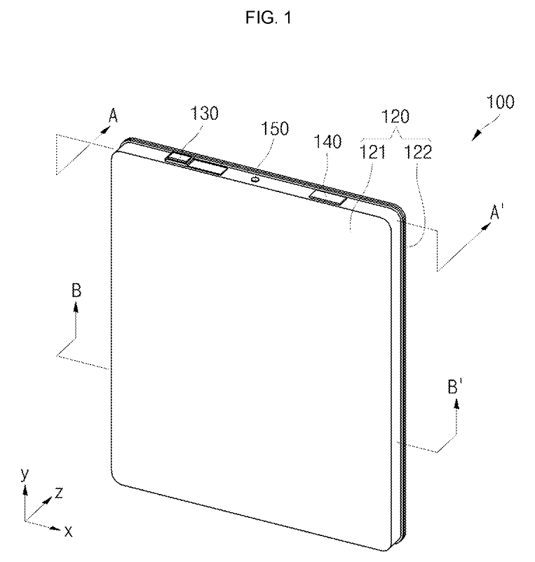

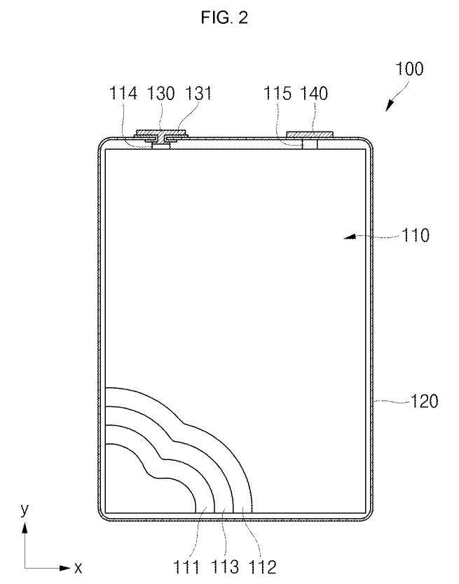

FIG. 1 is a perspective view of a secondary battery according to an embodiment of the present disclosure. FIG. 2 is a cross-sectional view taken along the line A-A' of the secondary battery shown in FIG. 1. As shown in FIGS. 1 and 2, a secondary battery 100, according to an embodiment of the present disclosure, may include an electrode assembly 110 and a case 120 accommodating the electrode assembly 110.

The case 120 may include a first case 121 having an approximately rectangular parallelepiped shape with one open side and a second case 122 coupled to the open side of the first case 121. The case 120 may provide (or may form) an outer shape of the secondary battery 100. The case 120 may include or may be referred to as a can, a housing, or an exterior material. The first case 121 and the second case 122 may include (or may be formed of) steel, stainless steel, nickel-plated steel, or a steel alloy. The first case 121 and the second case 122 include steel and, thus, may exhibit corrosion resistance and increased rigidity. The first case 121 may have an upper surface, a lower surface, and two short side surfaces extending in a third direction (e.g., the z direction) that is the rear direction from four edges of one front long side surface having a rectangular shape. The widths of the upper surface, lower surface, and two short side surfaces of the first case 121 may be the same. The second case 122 may be coupled to the open rear side of the first case 121, thereby completing the case 120 having a roughly hexahedral shape. A space may be provided on (or formed in) the inside of the first case 121 by drawing. The second case 122 may have a roughly flat plate shape. The first case 121 and the second case 122 may be sealed and coupled by welding. The case 120 is shaped to wrap around the electrode assembly 110, and the shape thereof may be variously changed depending on (e.g., to correspond to) the shape of the electrode assembly 110.

The electrode assembly 110 may be accommodated inside the case 120 together with an electrolyte. In some embodiments, however, the electrolyte may be omitted. The electrode assembly 110 may include or may be referred to as an electrode group, an electrode body, or a stack. The electrode assembly 110 may be stacked in a plate shape.

The electrode assembly 110 includes a first electrode plate 111, a second electrode plate 112, and a separator 113 interposed therebetween. In some embodiments, the electrode assembly 110 may be formed by stacking a stack of the first electrode plate 111, the separator 113, and the second electrode plate 112, which are formed in a thin plate shape or film shape. In some examples, one or more electrode assemblies 110 may be stacked such that the electrode assemblies 110 are adjacent to each other and accommodated in the case 120, and the number of electrode assemblies 110 in the case is not limited in the present disclosure. The first electrode plate 111 of the electrode assembly 110 may act as a negative electrode, and the second electrode plate 112 may act as a positive electrode. Of course, the reverse is also possible.

The first electrode plate 111 may be formed by applying a first electrode active material, such as a transition metal oxide, on a first electrode current collector formed of a metal foil, such as aluminum or an aluminum alloy. The first electrode plate 111 may include a first electrode active material layer that is a region to which the first electrode active material is applied. The first electrode plate 111 may include a first uncoated portion that is a region to which the first electrode active material is not applied.

The first electrode plate 111 may include a first electrode tab 114 electrically connected to the first uncoated portion. In some embodiments, the first electrode tabs 114 may be fixed (e.g., welded) to a first electrode non-coating portion in a generally flat shape. For example, the first electrode tabs 114 may be fixed to the first electrode non-coating portion by ultrasonic welding, laser welding, or resistance welding. That is, one end of the first electrode tab 114 may be electrically connected to the first electrode non-coating portion, and the other end may protrude and extend to the outside. In some embodiments, when the first electrode plate 111 is manufactured, the first electrode tab 114 may be formed by being cut in advance to protrude to one side of the electrode assembly 110, or the first electrode tab 114 may protrude to one side of the electrode assembly 110 more than (e.g., farther than or beyond) the separator 113 without being separately cut. The first electrode plate 111 may have the first electrode tab 114 extending outwardly, which is a first uncoated portion of a first substrate on which a first active material layer is not located. The first electrode tab 114 may be formed by punching out the first uncoated portion of the first electrode plate 111 or by coupling a separate tab to the first non-conductive portion. The first electrode tab 114 may be electrically connected to a first terminal 130.

As the positive electrode active material, which is the first active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹ _{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

The current collector may be aluminum (Al) but is not limited thereto.

The second electrode plate 112 may be formed by applying a second electrode active material, such as graphite or carbon, to a second electrode current collector formed of a metal foil, such as copper, a copper alloy, nickel, or a nickel alloy. The second electrode plate 112 may include a second electrode active material layer that is a region to which the second electrode active material is applied. The second electrode plate 112 may include a second uncoated portion that is a region to which the second electrode active material is not applied.

The second electrode plate 112 may include a second electrode tab 115 electrically connected to the second uncoated portion. In some embodiments, the second electrode tab 115 may be fixed (e.g., welded) to a second electrode non-coating portion in a generally flat shape. For example, the second electrode tabs 115 may be fixed to the second electrode non-coating portion by ultrasonic welding, laser welding, or resistance welding. That is, one end of the second electrode tab 115 may be electrically connected to the second electrode non-coating portion, and the other end may protrude and extend to the outside. In some embodiments, when the second electrode plate 112 is manufactured, the second electrode tab 115 may be formed by being cut in advance to protrude to one side of the electrode assembly 110, or the second electrode tab 115 may protrude to one side of the electrode assembly 110 more than (e.g., farther than or beyond) the separator 113 without being separately cut. The second electrode plate 112 may have a second electrode tab 115 extending outwardly, which is a second uncoated portion of a second substrate on which a second active material layer is not located. The second electrode tab 115 may be formed by punching out the second uncoated portion of the second electrode plate 112 or by coupling a separate tab to the second non-conductive portion. The second electrode tab 115 may be electrically connected to a second terminal 140.

The negative electrode active material, which is the second active material may include a material capable of reversibly intercalating/deintercalating lithium ions, lithium metal, an alloy of lithium metal, a material capable of being doped and dedoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and dedoped with lithium. The Si-based negative electrode active material may be silicon, a silicon-carbon composite, SiOx (0 < x < 2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The separator 113 may be interposed between the negative electrode plate 111 and the positive electrode plate 112 to prevent electrical short-circuit between the negative electrode plate 111 and the positive electrode plate 112. In some embodiments, the separator 113 are provided in a pair, and the negative electrode plate 111 may be sandwiched between the pair of separators 113.

Depending on the type of lithium secondary battery, the separator 113 may be present between the first electrode plate (e.g., the negative electrode) and the second electrode plate (e.g., the positive electrode). As the separator 113, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The secondary battery 100 may further include a first terminal 130 and a second terminal 140 provided on a top surface of the case 120. The first terminal 130 may be electrically insulated from the case 120 and may be in contact with and electrically connected to the first electrode tab 114 of the electrode assembly 110. The first electrode tab 114 of the electrode assembly 110 may be located between the first terminal 130 and the top surface of the electrode assembly 110. The first electrode tab 114 and the second electrode tab 115 may extend along a second direction (e.g., the y direction), which is a longitudinal direction of the electrode assembly 110.

An insulation member 131 may be interposed between the first terminal 130 and the case 120. The first terminal 130 may extend through and into (e.g., may penetrate) the case 120. Accordingly, the upper portion of the first terminal 130 may be exposed and protrude to the outside of the case 120, and the lower portion thereof may be located inside the case 120. The first electrode tab 114 of the electrode assembly 110 may be connected to the lower portion of the first terminal 130 by contact and welding. In some embodiments, the insulation member 131 may include or may be referred to as a gasket. Although shown as an integral part, the insulation member 131 may be composed of an insulating member in contact with the outer surface of the case 120, an insulating member in contact with the inner surface of the case 120, and a gasket located within a terminal hole of the case 120, and the insulation member 131 is not limited thereto in the present disclosure.

The second terminal 140 may be in contact with and electrically connected to the case 120. The second terminal 140 may constitute a portion of the case 120. The second terminal 140 may be electrically connected to the second electrode tab 115 of the electrode assembly 110. For example, the second electrode tab 115 may be in contact with and electrically connected to the case 120. The second terminal 140 may be electrically connected to a second electrode tab 115 of the electrode assembly 110 by the case 120. The second electrode tab 115 of the electrode assembly 110 may be located between the second terminal 140 and the top surface of the electrode assembly 110.

The secondary battery 100 may further include a plug 150 provided on (or in) the upper surface of the case 120. The case 120 may further include an electrolyte injection port provided in the upper surface between the first terminal 130 and the second terminal 140, and the electrolyte injection port may be sealed by the plug 150.

However, the present disclosure is not limited to this, and the case may have various shapes, such as a circular shape or a pouch shape. In some embodiments, the case may be composed of a metal, such as aluminum, an aluminum alloy, and nickel-plated steel, or a laminate film or plastic that constitutes a pouch.

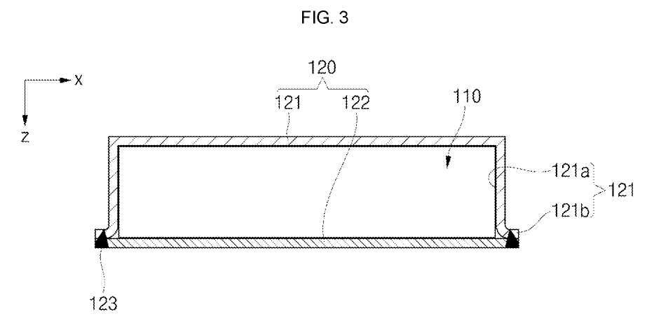

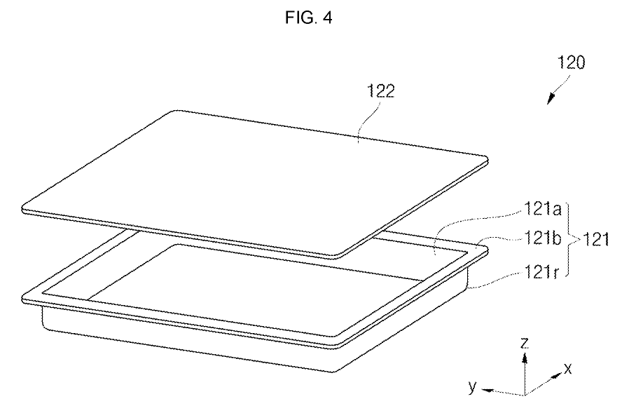

FIG. 3 is a cross-sectional view taken along the line B-B' of the secondary battery shown in FIG. 1. FIG. 4 is an exploded perspective view of the case of the secondary battery shown in FIG. 1. Hereinafter, the case 120 of the secondary battery 100 will be described in more detail with reference to FIGS. 3 and 4.

The case 120 may include the first case 121 having a roughly rectangular shape with an open back surface and the second case 122 having the shape of a flat plate that is coupled to the open back surface of the first case 121. After the electrode assembly 110 is accommodated in a recess 121a provided in (or formed in) the first case 121, the case 120 may be closed (e.g., sealed) by welding in a state in which the second case 122 is in contact with the first case 121.

The first case 121 may have a roughly rectangular shape and has a recess 121a provided at the center in the first direction (x) and the second direction (y). The recess 121ais a space for accommodating the electrode assembly 110 and may have a shape corresponding to the shape of the electrode assembly 110. In some embodiments, the recess 121amay be formed to have a size sufficient to accommodate the electrode assembly 110 through a press or drawing process. For example, the recess 121amay have a rectangular parallelepiped shape with one side open.

In some embodiments, an extension part 121b may be provided, which is bent from four edges of one end of the recess 121a to extend in an outward direction. The extension part 121bmay be integrally formed and may have an approximately square ring shape. In one embodiment, one end of the recess 121amay be located on an open side. In some embodiments, the outward direction may be a first direction (e.g., the x direction) and a second direction (the y direction) that are parallel to the second case 122. The extension part 121bmay be a surface that is parallel to the second case 122 and is coupled thereto. The second case 122 may be coupled by welding in a state in which the edge region thereof is in contact with the extension part 121b of the first case 121. Hereinafter, the region where the extension part 121b of the first case 121 and the edge region of the second case 122 are coupled by welding will be referred to as a coupling part 123.

In some embodiments, the coupling part 123 may be a region in which the first case 121 and the second case 122 are coupled by laser welding. For example, the coupling part 123 may be a region which is coupled by laser welding to be as close to the recess 121a as possible in the direction from the outer surface of second case 122 to the extension part 121b of the first case 121. The first case 121 and the second case 122 may be sealed in a state in which the electrode assembly 110 is accommodated therein by the coupling part 123. In some embodiments, the first case 121 and the second case 122 may have edge regions thereof removed, leaving only the minimum area where the coupling part 123 can secure airtightness, thereby preventing an unnecessary increase in the size of the case 120. For example, some areas of the extension part 121bof the first case 121 and some areas of the second case 122 located outside the coupling part 123 may be removed.

However, the present disclosure is not limited to this, and the first case 121 with the second case 122 may be combined without the extension part 121b.

The first case 121 may further include a round part 121rhaving a radius (e.g., a reference or certain radius) of curvature at each corner of the recess 121a. For example, the corner of the bottom surface of the recess 121a may be formed in a round shape.

In some embodiments, the first case 121 and the second case 122 may be made of stainless steel (SUS) or steel or a steel alloy having a plated layer formed on the surface thereof. In some embodiments, the first case 121 and the second case 122 may be made of the same material.

In this way, according to embodiments of the present disclosure, by reducing an unnecessary space of the case 120, a secondary battery having increased energy density and a method for manufacturing the same is provided.

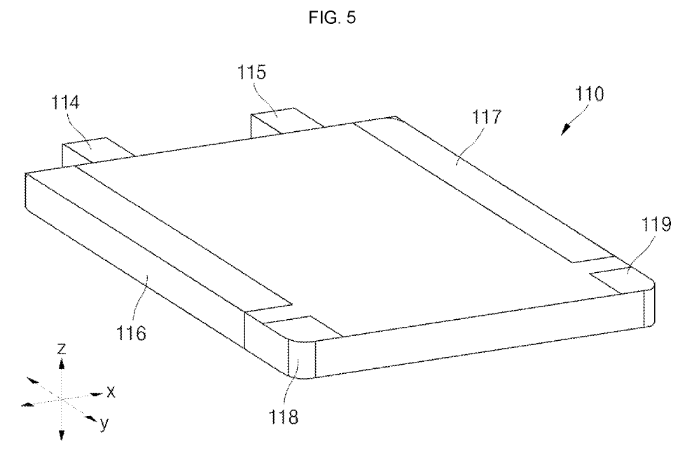

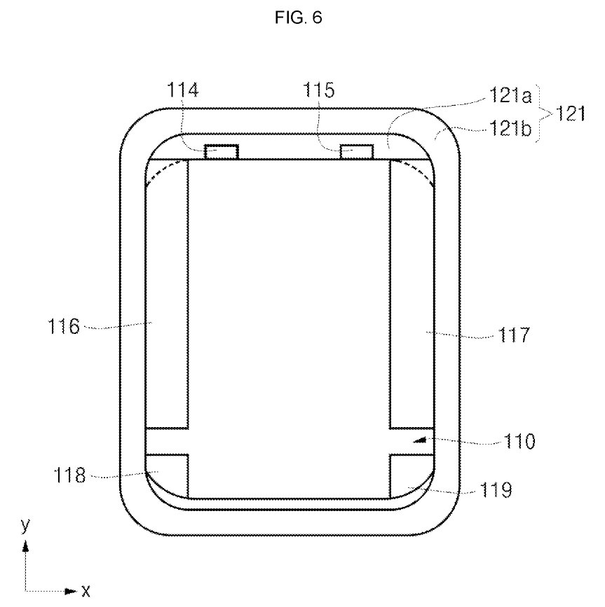

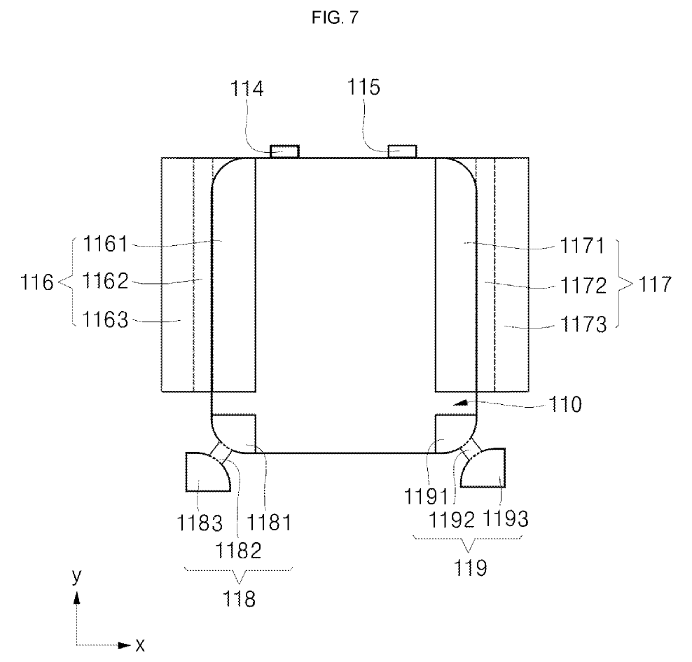

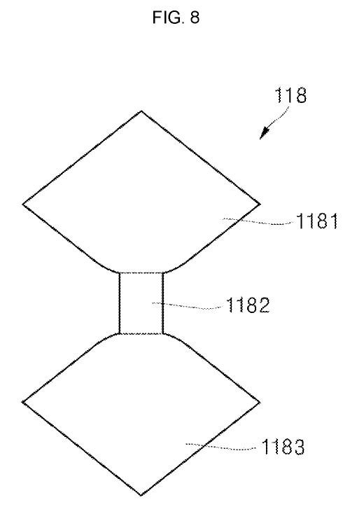

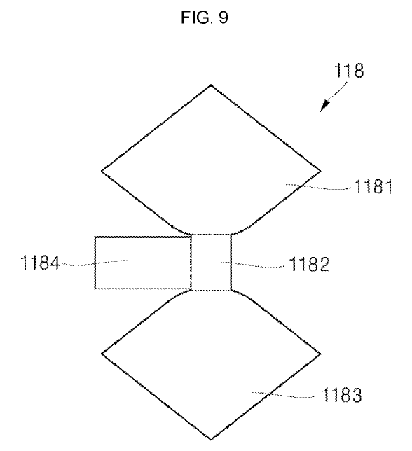

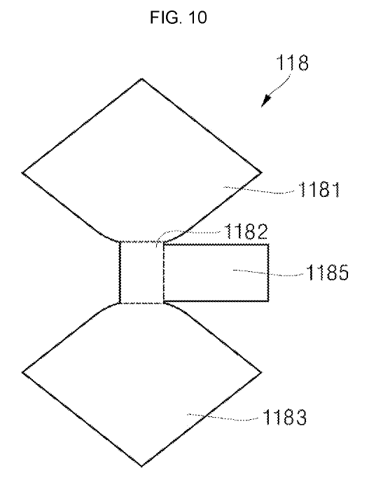

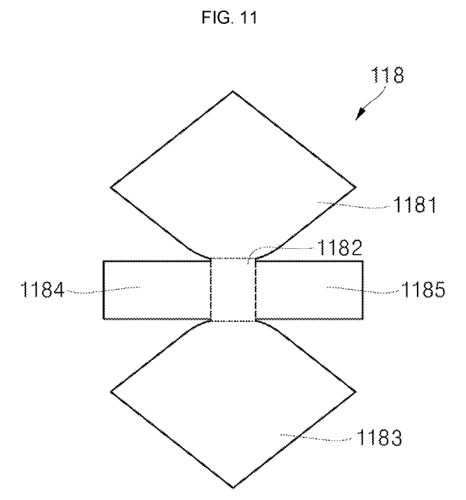

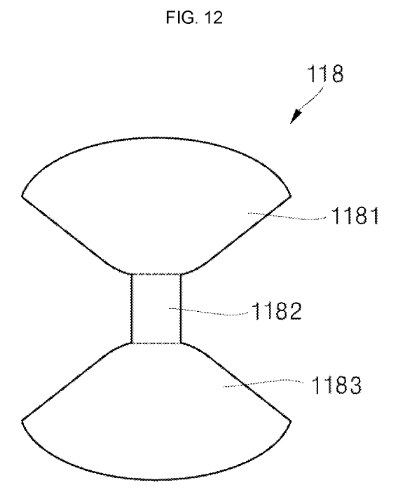

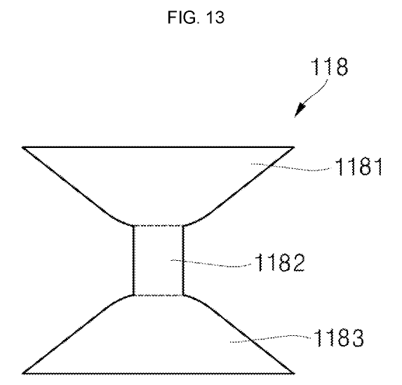

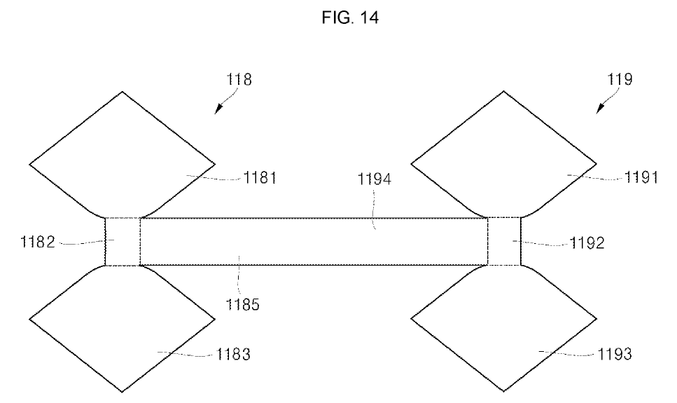

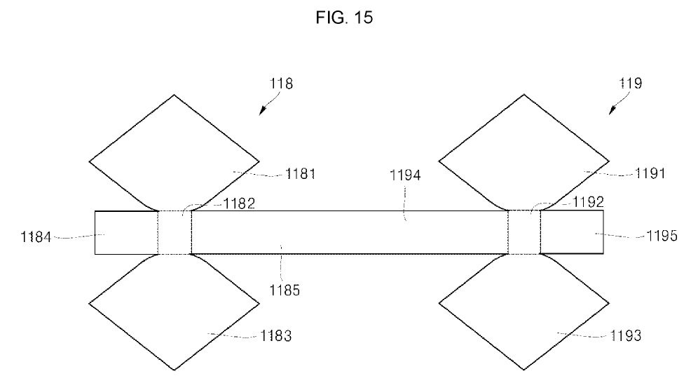

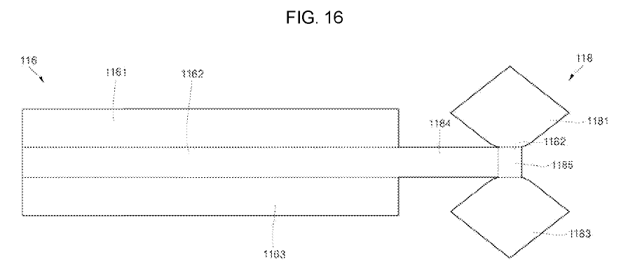

FIG. 5 is a perspective view of an electrode assembly of the secondary battery according to an embodiment of the present disclosure. FIG. 6 is a plan view of an electrode assembly shown in FIG. 5 accommodated in a case. FIG. 7 is a plan view showing a state before a cover member is wrapped around the electrode assembly shown in FIG. 5. FIG. 8 is a plan view of a second cover member according to an embodiment. FIG. 9 is a plan view of a second cover member including a wing part extending to one side according to an embodiment. FIG. 10 is a plan view of a second cover member including a wing part extending to the opposite side according to an embodiment. FIG. 11 is a plan view of a second cover member including wing parts extending to both sides according to an embodiment. FIG. 12 is a plan view of a fan-shaped second cover member according to an embodiment. FIG. 13 is a plan view of a trapezoidal second cover member according to an embodiment. FIG. 14 is a plan view of a second cover member integrally formed to wrap around both lower corners of an electrode assembly according to an embodiment. FIG. 15 is a plan view of a second cover member integrally formed to wrap around both lower corners of an electrode assembly and including a wing part according to an embodiment. FIG. 16 is a plan view of a first cover member and a second cover member integrally formed to wrap around an electrode assembly according to an embodiment. Hereinafter, with reference to FIGS. 5 -16, the electrode assembly 110 of the secondary battery 100 and first cover members 116 and 117 and second cover members 118 and 119 disposed on the electrode assembly 110 will be described.

Referring to FIGS. 5-7, the secondary battery 100 may include the electrode assembly 110, the first cover members 116 and 117, the second cover members 118 and 119, and the case 120 accommodating the same.

In some embodiments, in the electrode assembly 110, the first electrode tab 114 and the second electrode tab 115 protrude in the first direction (e.g., the y direction in FIG. 6) and have rounded corners. However, the protruding direction and position of the first electrode tab 114 and the second electrode tab 115 are not limited. In other embodiments, the respective electrode tabs may protrude in different directions and positions. In some embodiments, the electrode assembly 110 may be configured such that a negative electrode is positioned at the outermost portion but is not limited thereto. In some embodiments, the electrode assembly 110 may be accommodated at a location corresponding to the round part 121r having a radius of curvature at each corner of the recess 121a of the first case 121. In some embodiments, the lower portion of the electrode assembly 110, where the first electrode tab 114 and the second electrode tab 115 do not protrude, may be in contact with the lower portion of the case 120 to reduce a dead space.

For example, the radius value (R value) of the arc of at least one corner 121r of the first case 121 may be in a range of approximately 2.0 mm to approximately 2.5 mm. For forming the first case 121, the R value of approximately 2.0 mm or more may be used.

The R value refers to the radius of the rounded corner in a circle or arc with a fixed radius value, and the radius of curvature represents the immediate degree of curvature of a curve and may be defined as the reciprocal of the curvature (e.g., the degree of curvature) of the curve. In the case of a circle or arc with a constant R value, the R value and the radius of curvature may be the same, so the R value and the radius of curvature described in the present disclosure may have the same meaning (or may be the same value).

In some embodiments, the radius value (R value) of the corner of the electrode assembly 110 may be in a range of approximately 2.0 mm to approximately 3.5 mm. For example, the R value of the left corner of the electrode plate may be approximately 3.25 mm, and the R value of the right corner of the electrode plate may be approximately 2.25 mm. For example, the sizes of the left corner and the right corner of the electrode plate may be different from each other. In some embodiments, the sizes of the corners of positive and negative electrode plates may be different. For example, it may be that “positive electrode left corner R value > positive electrode right corner R value = negative electrode right corner R value > negative electrode left corner R value”. For example, the positive electrode left corner R value is the largest and the negative electrode left corner R value is the smallest.

In a process of cutting electrode plates, the cutting lines should intersect precisely. To achieve this, the electrode plate cutting process is divided into a cutter process in which straight line cutting is primarily performed, and an R-punch process in which corner portions are secondarily cut into curves. For the cutting lines to be naturally connected in these two processes, differential settings for the cutting curvature radius (R value) may be necessary. For example, by setting the radius of curvature (R₁) formed in the cutter process to be relatively small and setting the radius of curvature (R₂) formed in the R-punch process to be larger than R₁, the cutting lines can be sufficiently finished in the R-Punch process. By maintaining the relationship R₁<R₂ in this way, the cutting lines can naturally intersect, and no metal scrap or fine cutting residue (miscut) is generated. However, if R₁ is greater than or equal to R₂, there is insufficient area for additional cutting in the R-Punch process, so the cutting lines do not intersect precisely, which may cause a problem of miscutting. Therefore, to achieve complete cutting (complete punching) and prevent a cut loss, the radius of curvature may be set considering the intersection of the cutting lines between the cutting processes. The electrode assembly 110 may have cover members 116, 117, 118, and 119 disposed on the outside to perform the roles of fixing, pressing, aligning, and insulating. The cover members 116, 117, 118, and 119 can help to maintain the electrode assembly 110 in a stable manner, accurately align the positions of electrodes during assembling, and maintain a structurally complete form. In some embodiments, by having electrical insulating properties, the cover members 116, 117, 118, and 119 may prevent short circuits between electrodes. In some embodiments, the cover members may include or may be referred to as cover tapes, cover films, cover layers, cover membranes, or the like.

In some examples, the cover members 116, 117, 118, and 119 are made of materials with high strength, heat resistance, and insulating properties, and suitable materials may be selected depending on the intended use and environment. For example, the cover members 116, 117, 118, and 119 may be made of polyimide, polyethylene terephthalate (PET), an aramid fiber-based material, or an aluminum foil adhesive tape.

In some embodiments, the cover members 116, 117, 118, and 119 may include first cover members 116 and 117 disposed on a stacked side of the electrode assembly 110 and second cover members 118 and 119 disposed at corners of the electrode assembly 110.

In some embodiments, the second cover members 118 and 119 may be positioned to wrap around the uppermost side, sides (e.g., lateral sides), and lowermost side of the corners of the electrode assembly 110.

When the electrode assembly 110 having rounded corners is inserted into the case 120 in a state in which the cover member is disposed in the electrode assembly 110 in an angular shape, the cover member may interfere with the case 120, which may increase the possibility of welding defects due to the cover members being separated during welding of the case 120. To solve this, the size of an electrode plate may be reduced or the curvature of the round part 121rof the first case 121 may be adjusted. However, if the electrode plate size is reduced, the energy density will decrease, and if the curvature is reduced, the formability will not be good, which may be disadvantageous for stability evaluation (e.g., heat exposure, dropping, dents, etc.).

Accordingly, in an embodiment, the second cover members 118 and 119 are disposed to wrap around the rounded corners of the electrode assembly 110, which may eliminate interference with the case 120 and prevent the cover members from being separated during welding of the case 120, thereby reducing welding defects.

The second cover members 118 and 119 may be disposed at one or more corners on both sides opposite to the protruding direction of the first electrode tab 114 and the second electrode tab 115 of the electrode assembly 110. For convenience of explanation, with reference to FIG. 5, the second cover member positioned at the left corner is referred to as the left second cover member 118, and the second cover member positioned at the right corner is referred to as the right second cover member 119. Because the left second cover member 118 and the right second cover member 119 can be implemented with similar materials, shapes, and methods, for convenience of explanation, the following description will be made with reference to the left second cover member 118, which may be collectively referred to as the second cover member 118.

The second cover member 118 may include a bridge 1182 disposed on the side of the corner of the electrode assembly 110, an upper surface 1181 connected to the bridge 1182 and disposed on the uppermost side of the corner of the electrode assembly 110, and a lower surface 1183 connected to the bridge 1182 and disposed on the lowermost side of the corner of the electrode assembly 110.

In some embodiments, the length of the bridge 1182 may correspond to a stacked height of the electrode assembly 110. In some embodiments, one of the upper surface 1181 and the lower surface 1183 may correspond to the corner shape of the electrode assembly 110.

Referring to FIG. 8, the second cover member 118 may have an approximately diamond shape. The shape of two edges connected to the bridge 1182 from among the four edges of the upper surface 1181 and the lower surface 1183 and the shape of the portion where the bridge 1182 is connected may correspond to the corner shape of the electrode assembly 110. The angle between the two edges connected to the bridge 1182 may correspond to the angle of the corner of the electrode assembly 110. The dotted lines may indicate a portion that is folded at a bending position of the uppermost side, sides (e.g., lateral sides), and lowermost side of the electrode assembly 110.

Referring to FIG. 9, the second cover member 118 may further include a wing part 1184 extending from the bridge 1182 to one side. Referring to FIG. 10, the second cover member 118 may further include a wing part 1185 extending from the bridge 1182 to the other side. In some embodiments, referring to, for example, FIG. 11, the second cover member 118 may also include wing parts 1184 and 1185 extending from the bridge 1182 to both sides. The wing parts may more widely wrap around the stacked side of the electrode assembly 110, making fixing and alignment easier.

Referring to FIG. 12, the second cover member 118 may have an upper surface 1181 and a lower surface 1183 that are approximately fan-shaped. For example, two sides connected to the bridge 1182 of the upper surface 1181 and the lower surface 1183 may be connected by an arc.

Referring to FIG. 13, the second cover member 118 may have an upper surface 1181 and a lower surface 1183 that are approximately trapezoidal shape. For example, two edges connected to the bridge 1182 of the upper surface 1181 and the lower surface 1183 may be connected in a straight line. The shapes of the upper surface 1181 and the lower surface 1183 of the second cover member 118 may be modified in various ways within the technical concept of being disposed on the uppermost side and the lowermost side of the electrode assembly 110.

Referring to FIG. 14, the wing part 1185 of the left second cover member 118 may extend to the bridge 1192 of the right second cover member 119 disposed at the other corner. The wing part 1185 of the left second cover member 118 may be connected to the wing part 1194 of the right second cover member 119. In such an embodiment, the left second cover member 118 and the right second cover member 119 may be disposed at the corner of the electrode assembly 110 to integrally cover the bottom ends thereof.

Referring to FIG. 15, the left second cover member 118 may have a wing part 1184 formed to one side, and a wing part 1185 formed to the other side may extend to the right second cover member 119. In some embodiments, the right second cover member 119 may have a wing part 1195 formed to one side, and a wing part 1194 formed to the other side may extend to the left second cover member 118.

Referring to FIG. 16, a wing part 1184 of the left second cover member 118 may extend from the bridge 1182 to the first cover member 116. The first cover member 116 may include a first surface 1161, a second surface 1162, and a third surface 1163 disposed on the uppermost side of the electrode assembly 110. The wing part 1184 of the left second cover member 118 may be connected to the second surface 1162 of the first cover member 116.

For example, in some embodiments, the first cover member 116 and the second cover member 118 may be separate cover members but may also be connected to each other and integrally formed.

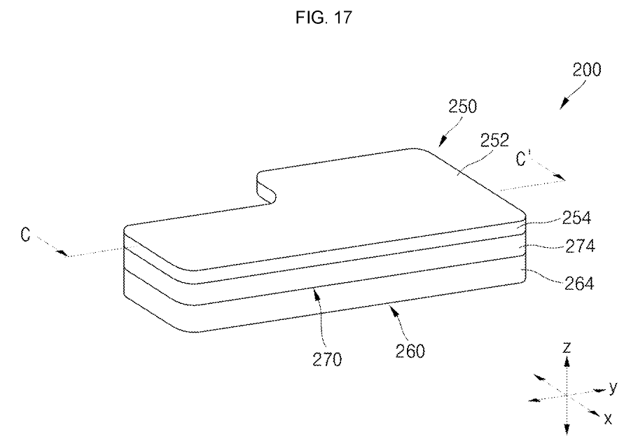

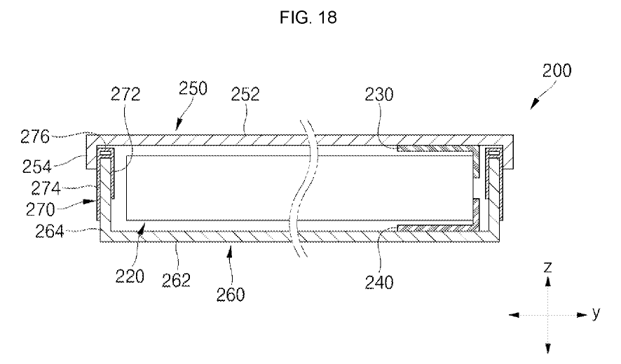

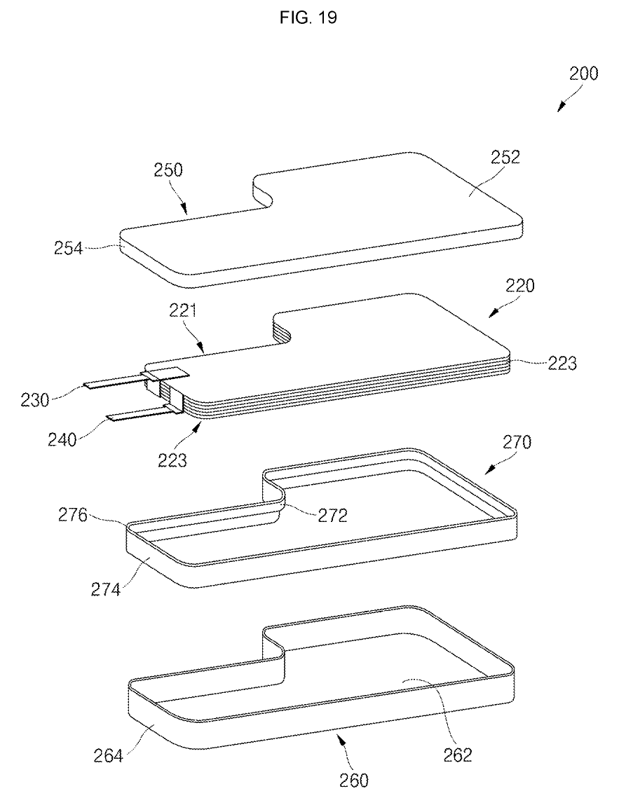

FIG. 17 is a perspective view of a secondary battery according to an embodiment of the present disclosure. FIG. 18 is a cross-sectional view taken along the line C-C’ of the secondary battery shown in FIG. 17. FIG. 19 is an exploded perspective view of the secondary battery shown in FIG. 17. A first electrode plate 221, a second electrode plate 222, and a separator 223 of the secondary battery 200 according to FIGS. 17-19 are similar in structure to the first electrode plate 111, the second electrode plate 112, and the separator 113 shown in FIGS. 1-3, and thus, a detailed description thereof is omitted.

As shown in FIGS. 17 and 18, the secondary battery 200, according to an embodiment of the present disclosure, may include an electrode assembly 220, a first case 250, a second case 260, and an insulating gasket 270. In some embodiments, the secondary battery 200 may further include at least one of a first electrode tab 230 and a second electrode tab 240. The secondary battery 200 may be referred to as a battery.

The first case 250 and the second case 260, which are installed with the insulating gasket 270 disposed therebetween, accommodate the electrode assembly 220 and an electrolyte and may form the outer shape of the secondary battery 200. The first case 250 and the second case 260 may include or may be referred to as a can, a housing, or an exterior material. The first case 250 and the second case 260 may include a metal, such as steel, nickel-plated steel, a steel alloy, aluminum, an aluminum alloy, a cold-rolled steel plate for deep drawing (SPCE), or a laminate film or plastic constituting a pouch. At least one of the first case 250 and the second case 260 may be provided with a beading part that is inwardly recessed. The beading part may protrude into the inside of the first case 250 and the second case 260 to suppress the electrode assembly 220 from moving.

Referring to FIG. 19, the electrode assembly 220 may be accommodated together with an electrolyte inside the first case 250 and the second case 260. The electrode assembly 220 may include a first electrode plate 221, a second electrode plate 222, and a separator 223 between the first electrode plate 221 and the second electrode plate 222. The electrode assembly 220 may be stacked in a plate shape. The electrode assembly 220 may be stacked in the order of the first electrode plate 221, the separator 223, and the second electrode plate 222. In some embodiments, the electrode assembly 220 may be installed in a shape in which the first electrode plate 221, the second electrode plate 222, and the separator 223, which are shaped of plates having a narrow portion and a wide portion connected in succession, are stacked.

The first electrode tab 230 may be connected to the first electrode plate 221 and may extend to the upper side of the electrode assembly 220 and may be electrically connected to the first case 250. The first electrode tab 230 may be electrically connected to a substrate tab provided on the first electrode plate 221. One side of the first electrode tab 230 is electrically connected to the first electrode plate 221 of the electrode assembly 220, and the other side of the first electrode tab 230 is fixed to the inner surface of the first case 250. The first electrode tab 230 may be fixed to the first case 250 by welding. The first electrode tab 230 may be connected to one longitudinal side (e.g., the left side in FIG. 19) of the first electrode plate 221. In some embodiments, the first electrode tab 230 may be a strip-shaped conductor. One side of the first electrode tab 230 may be electrically connected to a plurality of substrate tabs that extend/protrude from the electrode assembly 220.

The first electrode tab 230 may include copper, a copper alloy, nickel, a nickel alloy, aluminum, or an aluminum alloy. In some embodiments, the first electrode tab 230 may be bent upwardly from the electrode assembly 220 and then welded to the inside of the first case body 252. Thus, the polarity of the first electrode plate 221 and the polarity of the first case 250 may be the same.

The second electrode tab 240 may be connected to the second electrode plate 222 and may extend to the lower side of the electrode assembly 220 and may be electrically connected to the second case 260. The second electrode tab 240 may be electrically connected to a substrate tab provided on the second electrode plate 222. One side of the second electrode tab 240 is electrically connected to the second electrode plate 222 of the electrode assembly 220, and the other side of the second electrode tab 240 is fixed to the inner surface of the second case 260. The second electrode tab 240 may be fixed to the second case 260 by welding. The second electrode tab 240 may be connected to one longitudinal side (e.g., the left side in FIG. 19) of the second electrode plate 222. In some embodiments, the second electrode tab 240 may be a strip-shaped conductor. One side of the second electrode tab 240 may be electrically connected to a plurality of substrate tabs that extend/protrude from the electrode assembly 220.

The second electrode tab 240 may include copper, a copper alloy, nickel, a nickel alloy, aluminum, or an aluminum alloy. In some embodiments, the second electrode tab 240 may be bent upwardly from the electrode assembly 220 and then welded to the inside of the second case body 262. Thus, the polarity of the second electrode plate 222 and the polarity of the second case 260 may be the same.

The first case 250 is installed in a shape in which one side of the electrode assembly 220 is wrapped around and may be modified in various ways within the technical concept of being electrically connected to the first electrode plate 221. In some embodiments, the first case 250 covers the upper side of the electrode assembly 220 and may be electrically connected to the first electrode plate 221. The first case 250, according to one embodiment of the present disclosure, includes a first case body 252 and a first extension member 254. The first case body 252 is electrically connected to the first electrode tab 230 connected to the first electrode plate 221, and various modifications are possible within the technical concept of covering the upper side of the electrode assembly 220. The first extension member 254 extends downwardly from the edge of the first case body 252 and is located on the outside of the outer gasket 274. The shapes of the first case 250 and the second case 260 correspond to each other. The first case 250 may form a single component by connecting a narrow portion and a wide portion in the widthwise direction. The first case body 252 has a plate shape, and the widthwise length of the first case body 252 located on one side in the length direction may be shorter than the widthwise length of the first case body 252 located on the other side in the lengthwise direction. The first extension member 254 is installed along the edge of the first case body 252 and extends downwardly from the first case body 252. The first case 250 has an open lower side and is installed in a shape in which the upper side of the electrode assembly 220 is wrapped around. The first case 250 may be installed in a state of being in contact with the outer surface of the insulating gasket 270. The first case 250 may include at least one of aluminum, steel, stainless steel, injection-molded plastics, polymer composite materials, and glass fiber reinforced plastics.

The second case 260 is installed in a shape in which the other side of the electrode assembly 220 is wrapped around, and various modifications are possible within the technical concept of being electrically connected to the second electrode plate 222. In some embodiments, the second case 260 covers the lower side of the electrode assembly 220 and may be electrically connected to the second electrode plate 222. The second case 260 accommodates the electrode assembly 220, and various modifications are possible within the technical concept of being covered on the upper side by the first case 250. The second case 260 is positioned on the lower side of the first case 250, and the upper end of the second case 260 may be positioned inside the first case 250. The first case 250 and the second case 260 are made of conductors and may have different polarities.

The second case 260, according to one embodiment of the present disclosure, includes a second case body 262 and a second extension member 264. The second case body 262 is electrically connected to the second electrode tab 240 connected to the second electrode plate 222, and various modifications are possible within the technical concept of covering the lower side of the electrode assembly 220. The second extension member 264 extends upwardly from the edge of the second case body 262 and is positioned between an outer gasket 274 and an inner gasket 272.

The second case 260 may form a single component (e.g., an integral element) by connecting a narrow portion and a wide portion in the widthwise direction. The second case body 262 has a plate shape, and the widthwise length of the second case body 262 located on one side in the lengthwise direction may be shorter than the widthwise length of the second case body 262 located on the other side in the lengthwise direction. The second extension member 264 is installed along the edge of the second case body 262 and extends upwardly from the second case body 262. The second case 260 has an open upper shape and is installed in a shape in which the lower side of the electrode assembly 220 is wrapped around. The second extension member 264 of the second case 260 may be installed in a state of being inserted into the inner side of the insulating gasket 270. The second case 260 may include at least one of aluminum, steel, stainless steel, hot-cast plastics, polymer composite materials, and glass fiber reinforced plastics.

In some embodiments, the electrode assembly 220, the first case 250, and the second case 260 may constitute an amorphous secondary battery having an “L” shape. The electrode assembly 220 may be formed in an “L” shape, and the first case 250 and the second case 260, which wrap around the outside of the electrode assembly 220, may also be formed in an “L” shape corresponding to the shape of the electrode assembly. The shapes of the electrode assembly 220, the first case 250 and the second case 260 may be modified into various shapes, such as shapes of being bent multiple times.

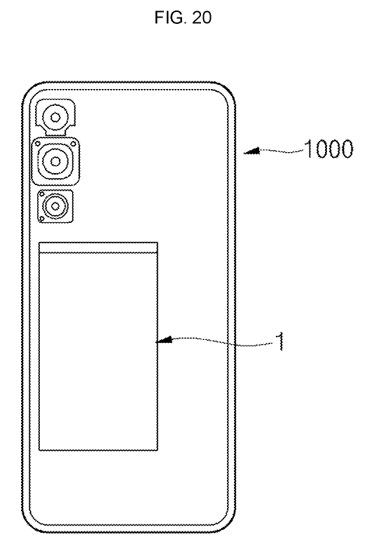

FIG. 20 is a view schematically showing a smartphone 1000 equipped with a secondary battery 1 according to an embodiment of the present disclosure. As shown in FIG. 20, a secondary battery 1 according to the above-described embodiment of the present disclosure may be a small battery mounted in a small portable device such as a smartphone 1000. The secondary battery 1 may include the secondary battery 100 and the secondary battery 200, which have been described above. In this case, because the exemplary secondary battery 1 is configured to be able to increase the capacity thereof while having a slim internal structure, the above-described secondary battery 1 may be a battery suitable for application to small portable devices. As used herein, the terms “secondary battery pack” and “battery” have the same meaning and are different only in expression for convenience of description.

Although the present disclosure has been described with reference to embodiments and drawings illustrating aspects thereof, the present disclosure is not limited thereto. Various modifications and variations can be made by a person skilled in the art to which the present disclosure belongs.

What is claimed is:

1. A secondary battery comprising:
an electrode assembly comprising a first electrode plate, a second electrode plate, and a separator laminated on each other, the electrode assembly having rounded corners;
a first cover member on a stacked side of the electrode assembly;
a second cover member at a corner of the electrode assembly and covering an uppermost side, lateral sides, and a lowermost side of the corner of the electrode assembly; and
a case accommodating the electrode assembly, the first cover member, and the second cover member.

2. The secondary battery as claimed in claim 1, wherein the second cover member is at a plurality of corners of the electrode assembly.

3. The secondary battery as claimed in claim 1, wherein the second cover member has a shape corresponding to the corner shape of the electrode assembly.

4. The secondary battery as claimed in claim 1, wherein the second cover member comprises:
a bridge on the lateral side of the corner of the electrode assembly;
an upper surface connected to the bridge and on the uppermost side of the corner of the electrode assembly; and
a lower surface connected to the bridge and on the lowermost side of the corner of the electrode assembly.

5. The secondary battery as claimed in claim 4, wherein a length of the bridge corresponds to a stacked height of the electrode assembly.

6. The secondary battery as claimed in claim 4, wherein the upper surface and the lower surface have a rhombus, trapezoid, or fan shape.

7. The secondary battery as claimed in claim 4, wherein the second cover member further comprises a wing part extending from the bridge to one side.

8. The secondary battery as claimed in claim 7, wherein the wing part extends in a stacking surface of the electrode assembly.

9. The secondary battery as claimed in claim 7, wherein the wing part extends from the bridge of the second cover member at one corner of the electrode assembly to the bridge of the second cover member at the other corner of the electrode assembly.

10. The secondary battery as claimed in claim 7, wherein the wing part further comprises an extending wing part that wraps around the uppermost side and the lowermost side of the electrode assembly.

11. The secondary battery as claimed in claim 7, wherein the wing part extends from the bridge of the second cover member disposed at one corner to the first cover member.

12. The secondary battery as claimed in claim 1, wherein the first cover member comprises:
a first surface on the uppermost side of the electrode assembly;
a second surface extending from the first surface and on a stacking surface of the electrode assembly; and
a third surface extending from the second surface and on the lowermost side of the electrode assembly.

13. The secondary battery as claimed in claim 1, wherein the first cover member and the second cover member are integrally formed.

14. The secondary battery as claimed in claim 1, wherein the first cover member and the second cover member are separated from each other.

15. The secondary battery as claimed in claim 1, wherein an R value, which is a radius of an arc of the corner of the electrode assembly, is in a range of 2.0 mm to 3.5 mm.

16. The secondary battery as claimed in claim 1, wherein an R value, which is a radius of an arc of the corner of at least one surface of the case, is in a range of 2.0 mm to 2.5 mm.

17. The secondary battery as claimed in claim 1, wherein a left corner and a right corner of the electrode assembly have different radii.

18. The secondary battery as claimed in claim 1, wherein the case comprises:
a first case having a recess in a central area for accommodating the electrode assembly therein and having one open side; and
a second case sealing the open side of the first case,
wherein the first case comprises an extension part extending from one end of the recess and coupled to the second case.

19. The secondary battery as claimed in claim 18, wherein the recess of the first case has a round portion corresponding to the corner of the electrode assembly.

20. The secondary battery as claimed in claim 1, wherein the case is made of steel, stainless steel, nickel-plated steel, or a steel alloy.
